(19) United States
(12) Patent Application Publication
(10) Pub. No.: US 2025/0388284 A1
(43) Pub. Date: Dec. 25, 2025

(54) INTAKE STRUCTURE

(71) Applicant: SUZUKI MOTOR CORPORATION, Hamamatsu-shi (JP)

(72) Inventor: Kyoma SUZUKI, Hamamatsu-shi (JP)

(73) Assignee: SUZUKI MOTOR CORPORATION, Hamamatsu-shi (JP)

(21) Appl. No.: 19/246,480

(22) Filed: Jun. 23, 2025

(30) Foreign Application Priority Data
Jun. 25, 2024 (JP) 2024-101681

(51) Int. Cl. B62J 40/10; B62J 17/10

(52) U.S. Cl. CPC B62J 40/10; B62J 17/10

(57) ABSTRACT

An intake structure for a straddle-type vehicle for guiding air toward an intake port of an air cleaner is provided. The intake structure includes a seat that is located above the air cleaner, and a rear fender that is located behind the air cleaner. A rear lower surface of the seat and a front upper surface of the rear fender face each other to form an intake passage. A recess that extends from a position behind a rear end of the seat to a position in front of the rear end of the seat in a top view of the straddle-type vehicle is formed in the front upper surface of the rear fender.

### CROSS-REFERENCE TO RELATED APPLICATIONS

This application is based on and claims priority under 35 USC 119 from Japanese Patent Application No. 2024-101681 filed on Jun. 25, 2024, the contents of which are incorporated herein by reference.

### BACKGROUND

The present invention relates to an intake structure.

As a straddle-type vehicle, a type of straddle-type vehicle is present in which an air cleaner is provided below a seat and the periphery of the air cleaner is covered with various rigging components (for example, see JP2011-73468A). In the straddle-type vehicle described in JP2011-73468A, the air cleaner is covered with the seat from above, the air cleaner is covered with a pair of side covers from both sides, and the air cleaner is covered with a rear fender from behind. An intake port is formed in the air cleaner, and a gap is formed between the seat and the rigging component such as the rear fender. Air is taken into the intake port of the air cleaner through the gap between the seat and the rigging component.

### SUMMARY OF INVENTION

According to one advantageous aspect of the invention, there is provided an intake structure for a straddle-type vehicle for guiding air toward an intake port of an air cleaner, the intake structure including:
a seat that is located above the air cleaner; and
a rear fender that is located behind the air cleaner,
wherein a rear lower surface of the seat and a front upper surface of the rear fender face each other to form an intake passage, and
wherein a recess that extends from a position behind a rear end of the seat to a position in front of the rear end of the seat in a top view of the straddle-type vehicle is formed in the front upper surface of the rear fender.

According to the intake structure in the aspect of the present invention, the intake passage is widened by forming the recess in the upper surface of the rear fender, and the amount of intake air that is guided to the intake port of the air cleaner can be increased to improve the engine output. Since the foreign matter such as water or mud that is splashed by the rear wheel is less likely to adhere to the upper surface of the rear fender, the foreign matter can be prevented from entering the intake port even if the recess is formed in the upper surface of the rear fender. Therefore, it is possible to ensure a sufficient amount of intake air while preventing the foreign matter from entering the air cleaner.

### BRIEF DESCRIPTION OF DRAWINGS

FIG. 1 is a left side view of a straddle-type vehicle according to the present embodiment.

FIG. 2 is a top view of the peripheral portion of an air cleaner according to the present embodiment.

FIG. 3 is a cross-sectional view of the peripheral portion of the air cleaner in FIG. 2 taken along a line A-A.

FIG. 4 is a top view of an intake structure of the straddle-type vehicle according to the present embodiment.

FIG. 5 is a rear view of the intake structure of the straddle-type vehicle according to the present embodiment.

FIG. 6 is a perspective view of the intake structure of the straddle-type vehicle according to the present embodiment.

FIG. 7 is a cross-sectional view of the intake structure of the straddle-type vehicle in FIG. 5 taken along a line B-B.

### DESCRIPTION OF EMBODIMENTS

In the straddle-type vehicle described in JP2011-73468A, it is necessary to set the gap between the seat and the rigging component to be narrow in order to prevent entry of the foreign matter such as water or mud. However, when the gap is narrow, there is a possibility that intake of the air cleaner becomes insufficient and a satisfactory engine output cannot be attained.

The present invention has been made in view of the above points, and an object of the present invention is to provide an intake structure capable of ensuring a sufficient amount of intake air while preventing the foreign matter such as water and mud from entering an air cleaner.

An intake structure for guiding air toward an intake port of an air cleaner is formed in a straddle-type vehicle according to an aspect of the present invention. A seat is located above the air cleaner, a rear fender is located behind the air cleaner, and a rear lower surface of the seat and a front upper surface of the rear fender face each other to form an intake passage. The front upper surface of the rear fender is formed with a recess that extends from a position behind a rear end of the seat to a position in front of the rear end of the seat in a top view. The intake passage is widened by the recess in the upper surface of the rear fender, and the amount of intake air that is guided to the intake port of the air cleaner can be increased to improve the engine output. Since the foreign matter such as water or mud that is splashed by the rear wheel is less likely to adhere to the upper surface of the rear fender, the foreign matter can be prevented from entering the intake port even if the recess is formed in the upper surface of the rear fender. Therefore, it is possible to ensure a sufficient amount of intake air while preventing the foreign matter from entering the air cleaner.

### EMBODIMENT

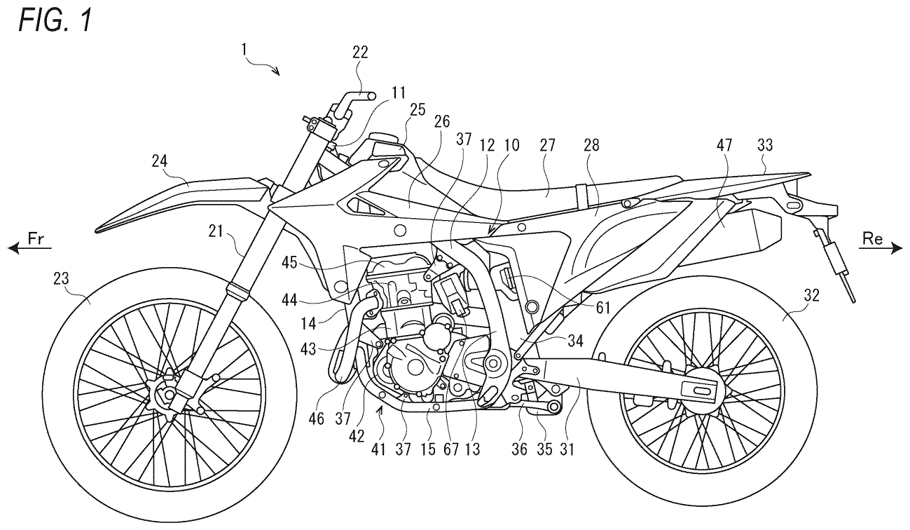

A straddle-type vehicle provided with an air cleaner according to the present embodiment will be described below with reference to the accompanying drawings. FIG. 1 is a left side view of the straddle-type vehicle according to the present embodiment. In the following drawings, an arrow Fr indicates the vehicle front side, an arrow Re indicates the vehicle rear side, an arrow L indicates the vehicle left side, and an arrow R indicates the vehicle right side.

As shown in FIG. 1, a straddle-type vehicle 1 is implemented by mounting various components such as an engine 41 and an electrical system on a vehicle body frame 10. A pair of main frames 12 extend obliquely rearward and downward from a head pipe 11 of the vehicle body frame 10, and the rear portions of the pair of main frames 12 form a pair of body frames 13 bent downward. A down frame 14 extends downward from the head pipe 11, and an under loop 15 bent rearward is connected to the lower portion of the down frame 14. The rear end portions of the pair of under loops 15 are connected to the lower portions of the pair of body frames 13, so that the vehicle body frame 10 is formed into a cradle shape.

A front fork 21 is steerably supported on the head pipe 11 via a steering shaft (not shown). A handle 22 is provided at the upper portion of the front fork 21, and a front wheel 23 is rotatably supported on the lower portion of the front fork 21. The front wheel 23 is covered from above with a front fender 24 that is provided on the front fork 21. A fuel tank 25 is placed over the upper portions of the pair of main frames 12, and the main frames 12 and the fuel tank 25 are covered with a front side cover 26 from the lateral side. A seat 27 is provided behind the fuel tank 25, and a pair of side covers 28 are provided below the seat 27.

A swing arm 31 is swingably supported on the body frame 13. The swing arm 31 extends rearward from the body frame 13, and a rear wheel 32 is rotatably supported on the rear end portion of the swing arm 31. The rear wheel 32 is covered from above with a rear fender 33 that is provided behind the seat 27. The swing arm 31, a rear suspension 34, and the body frame 13 are connected via a cushion lever 35 and a cushion rod 36. The rear suspension 34 extends and contracts according to swinging of the swing arm 31, so that the unevenness of a road surface is absorbed and vibration is prevented, and the ground contact property between the road surface and the rear wheel 32 is improved.

The engine 41 is a four-stroke, single-cylinder engine, and is suspended inside the vehicle body frame 10 via a suspension bracket 37. A cylinder assembly in which a cylinder 43, a cylinder head 44, and a cylinder head cover 45 are stacked is attached to the upper portion of a crank case 42 of the engine 41. An exhaust pipe 46 is connected to the front surface of the cylinder head 44. The exhaust pipe 46 extends rearward passing through the right side of the cylinder 43, and an up-type muffler 47 that is tilted obliquely upward and rearward is connected to the downstream end of the exhaust pipe 46. An intake device such as an air cleaner 61 is provided behind the cylinder head 44.

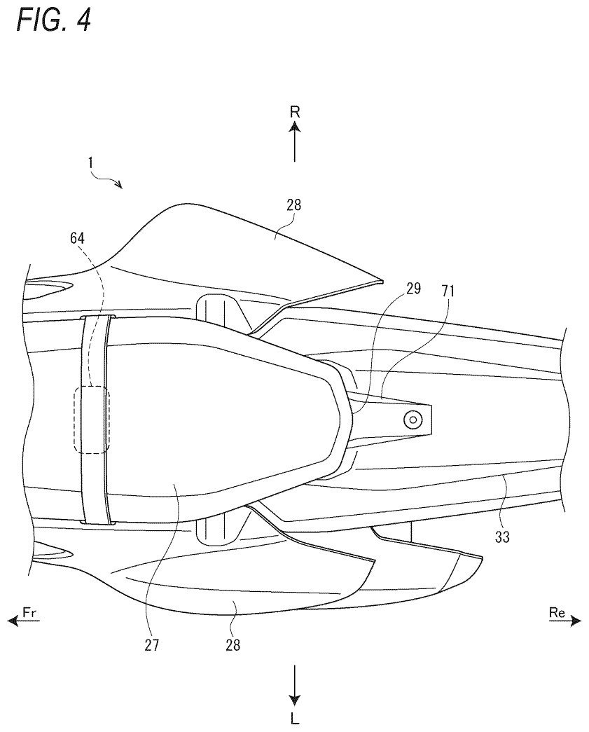

In a general off-road vehicle, the intake port of the air cleaner is positioned below the seat, and air is taken into the intake port through the gap between the seat and the rigging component such as the rear fender. By narrowing the gap between the seat and the rigging component, it is possible to prevent the foreign matter such as water and mud from entering the intake port, and to hide the component under the seat to improve the appearance. However, the amount of intake air of the air cleaner is reduced and a sufficient engine output cannot be attained. Therefore, in the present embodiment, a recess 71 (see FIG. 4) is formed in the upper surface of the rear fender 33, which is less likely to allow the foreign matter such as water or mud splashed onto the rear wheel 32 to adhere thereto and has little influence on the appearance, to increase the amount of intake air of the air cleaner 61.

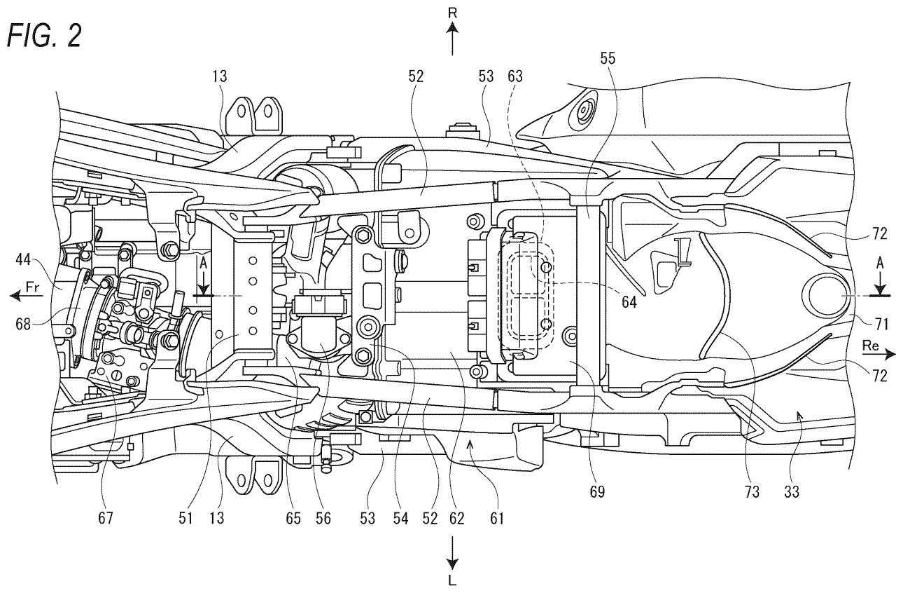

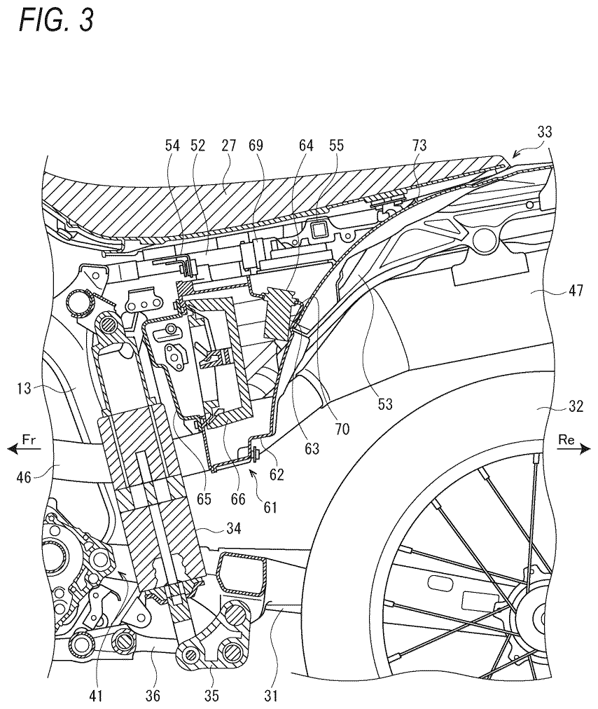

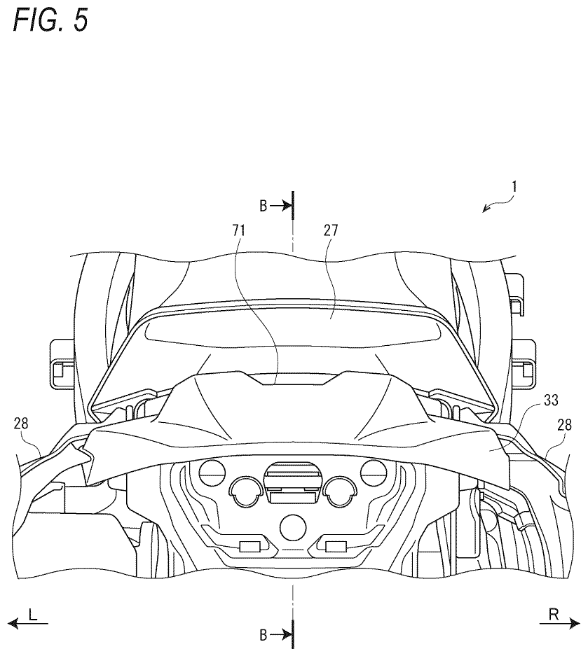

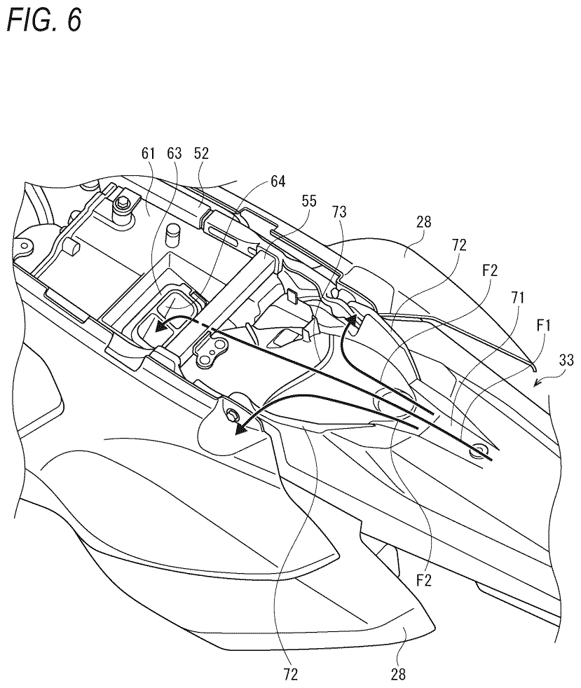

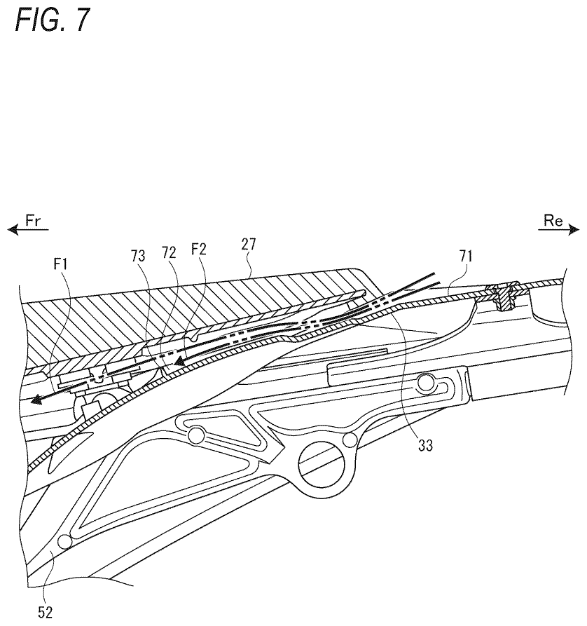

The intake structure for the straddle-type vehicle according to the present embodiment will be described with reference to FIGS. 2 to 7. FIG. 2 is a top view of the peripheral portion of the air cleaner according to the present embodiment. FIG. 3 is a cross-sectional view of the peripheral portion of the air cleaner in FIG. 2 taken along a line A-A. FIG. 4 is a top view of the intake structure of the straddle-type vehicle according to the present embodiment. FIG. 5 is a rear view of the intake structure of the straddle-type vehicle according to the present embodiment. FIG. 6 is a perspective view of the intake structure of the straddle-type vehicle according to the present embodiment. FIG. 7 is a cross-sectional view of the intake structure of the straddle-type vehicle in FIG. 5 taken along a line B-B. FIG. 6 shows a state in which a seat and an engine control module (ECM) are removed from the straddle-type vehicle.

As shown in FIGS. 2 and 3, the upper portions of the pair of body frames 13 are connected via a frame bridge 51, and upper seat rails 52 extend rearward from the upper portions of the pair of body frames 13. A pair of lower seat rails 53 extend obliquely upward and rearward from the lower portions of the pair of body frames 13, and the rear end portions of the pair of lower seat rails 53 are connected to the rear end portions of the pair of upper seat rails 52. The front portions of the pair of upper seat rails 52 are connected via a sensor bracket 54, and the rear portions of the pair of upper seat rails 52 are connected via a seat bridge 55.

An accelerator position sensor 56 is supported on the sensor bracket 54. The air cleaner 61 is provided in a space inside the pair of upper seat rails 52 and the pair of lower seat rails 53. The rear side of the air cleaner 61 is formed by a cleaner case 62, and the front side of the air cleaner 61 is formed by an outlet tube 65. The center of the upper surface of the rear portion of the cleaner case 62 is recessed, and an inlet tube 63 is inserted into the bottom surface of this recess 70. The upper and rear sides of the recess 70 of the cleaner case 62 are open, and an intake port 64 of the inlet tube 63 faces upward.

An ECM 69 is provided on the upper surface of the rear portion of the cleaner case 62 so as to cover the intake port 64 of the inlet tube 63 from above. The rear surface of the cleaner case 62 is curved, and the front side of the rear fender 33 is attached to the rear surface of the cleaner case 62. The bottom surface of the recess 70 of the cleaner case 62 is lowered toward the vehicle rear side, and the rear of the inlet tube 63 is covered with the curved surface of the rear fender 33. Air is taken into the cleaner case 62 from the intake port 64 of the inlet tube 63 through the gap between the ECM 69 and the curved surface of the rear fender 33.

A filter 66 is provided inside the cleaner case 62, and air taken in from the inlet tube 63 is filtered by the filter 66 and sent to the outlet tube 65. The outlet tube 65 is connected to the cylinder head 44 via an electronically controlled throttle 67 and an intake pipe 68. The air filtered by the filter 66 is sent from the outlet tube 65 to the electronically controlled throttle 67, and after the amount of intake air is adjusted by the electronically controlled throttle 67, the air is supplied from the electronically controlled throttle 67 to the cylinder head 44 through the intake pipe 68.

As shown in FIGS. 4 and 5, an intake structure that guides air to the intake port 64 of the air cleaner 61 by the seat 27 and the rear fender 33 is formed in the rear portion of the straddle-type vehicle 1. The seat 27 is provided above the air cleaner 61, the pair of side covers 28 are provided on both sides of the air cleaner 61, and the rear fender 33 is provided behind the air cleaner 61. The air cleaner 61 is surrounded by the seat 27, the pair of side covers 28, and the rear fender 33, and air is suctioned into the intake port 64 of the air cleaner 61 from the gap between the seat 27 and the side cover 28 and the gap between the seat 27 and the rear fender 33.

The rear lower surface of the seat 27 and the front upper surface of the rear fender 33 face each other to form an intake passage. The recess 71 that is long in the front-rear direction is provided on the front upper surface of the rear fender 33. The recess 71 extends from a position behind a rear end 29 of the seat 27 to a position in front of the rear end 29 of the seat 27 in the top view. That is, in the top view, the front end of the recess 71 is located inside the seat 27, and the rear end of the recess 71 is located outside the seat 27. As described above, air is suctioned from the gap between the seat 27 and the side cover 28. The gap between the seat 27 and the rear fender 33 is widened by the recess 71, and air is suctioned mainly from the recess 71.

The recess 71 is wider from the rear toward the front in the top view. The design is improved. The front upper surface of the rear fender 33 is curved downward toward the front, and the recess 71 is formed deeper toward the front according to the fender shape. The intake passage is widened from the rear to the front of the recess 71 so that air flows smoothly, and the rear end side (the inlet side) of the recess 71 is narrowed so that entry of the foreign matter is prevented. The recess 71 is wider upward from the bottom surface in the rear view. Since the foreign matter such as water enters along the bottom surface, the bottom surface of the recess 71 is narrowed to prevent entry of the foreign matter.

As shown in FIGS. 2 and 6, a pair of wall portions 72 are provided on the front upper surface of the rear fender 33. The pair of wall portions 72 extend forward from both ends of the front end portion of the recess 71 in the vehicle width direction, and the pair of wall portions 72 are curved in an arc shape so as to widen the facing interval from the rear toward the front in the top view. The pair of wall portions 72 gradually widen the intake passage from the recess 71 toward the intake port 64, and air flows smoothly. The pair of wall portions 72 protrude upward from the front upper surface of the rear fender 33, and the gap between the seat 27 and the rear fender 33 is filled with the pair of wall portions 72 to improve the design.

As shown in FIGS. 6 and 7, a horizontally long rib 73 is provided on the front upper surface of the rear fender 33, and the rib 73 extends in the vehicle width direction across the intake passage in the top view. The width of the rib 73 is larger than the width of the recess 71 and the width of the intake port 64. The height of the rib 73 decreases outward in the vehicle width direction according to the shape of the rear fender 33. The intermediate position of the rib 73 in the vehicle width direction is the highest, and the height of the rib 73 at the intermediate position is the same as the height of the wall portion 72. A passage for air is secured above the rib 73, and the flow of water or the like along the surface of the rear fender 33 is blocked by the rib 73. The rib 73 prevents the foreign matter from entering the intake port 64 without hindering air intake into the intake port 64.

The rib 73 is curved so as to be convex rearward in the top view, and the flow of water or the like is guided outward in the vehicle width direction by the rib 73, so that the foreign matter is less likely to head toward the intake port 64. The rib 73 is located above the intake port 64 (see FIG. 3), and the height of the rib 73 is kept small, so that the flow of air toward the intake port 64 is less likely to be hindered. The height of the rib 73 is reduced, so that the influence on the peripheral components is reduced, and the degree of freedom in the shape of the rear fender 33 is improved. The rib 73 is closer to the recess 71 than is the intake port 64. In other words, a distance between the rib 73 and the recess 71 is shorter than a distance between the rib 73 and the intake port 64. Entry of the foreign matter is prevented at a position away from the intake port 64. The gap below the seat 27 is filled with the rib 73, thereby improving the design.

An intake passage at the rear portion of the vehicle will be described with reference to FIGS. 6 and 7. As shown in FIGS. 6 and 7, the intake passage is formed between the lower surface of the seat 27 and the upper surface of the rear fender 33. The recess 71 is formed in the upper surface of the rear fender 33 to widen the intake passage, and air is easily taken in from the vehicle rear side to below the seat 27 through the recess 71. The pair of wall portions 72 are provided on the front side of the recess 71, and the intake passage is widened toward the vehicle front side by the pair of wall portions 72 below the seat 27. As indicated by an arrow F1, air is smoothly guided toward the intake port 64 (see FIG. 3) by the recess 71 and the pair of wall portions 72.

The foreign matter such as water or mud is splashed by the rear wheel 32 (see FIG. 1). The foreign matter is less likely to enter the recess 71 on the upper surface side of the rear fender 33. Even if the foreign matter enters the recess 71, the rib 73 on the upper surface of the rear fender 33 prevents entry of the foreign matter. As indicated by an arrow F2, the foreign matter such as water flows along the upper surface of the rear fender 33. The foreign matter is guided outward in the vehicle width direction along the rib 73 and discharged to the outside. Since the height of the rib 73 is reduced and the air flows above the rib 73, the flow of the air is less likely to be blocked by the rib 73, and the influence on the amount of intake air is minimized.

As described above, according to the intake structure of the straddle-type vehicle 1 in the present embodiment, the intake passage is widened by forming the recess 71 in the upper surface of the rear fender 33, and the amount of intake air that is guided to the intake port 64 of the air cleaner 61 can be increased to improve the engine output. Since the foreign matter such as water or mud that is splashed by the rear wheel 32 is less likely to adhere to the upper surface of the rear fender 33, the foreign matter can be prevented from entering the intake port 64 even if the recess 71 is formed in the upper surface of the rear fender 33. Therefore, it is possible to ensure a sufficient amount of intake air while preventing the foreign matter from entering the air cleaner 61.

In the present embodiment, the recess is wider from the rear toward the front, but it is sufficient that the recess extends from the rear to the front.

In the present embodiment, the rib and the pair of wall portions are provided on the upper surface of the rear fender, but it is sufficient that the upper surface of the rear fender is formed with at least a recess, and the rib and the pair of wall portions may not be provided.

In the present embodiment, the rib is curved so as to be convex rearward in the top view, but the curved shape of the rib is not limited as long as the rib extends in the vehicle width direction so as to cross the intake passage.

The intake structure according to the present embodiment is not limited to being used in the above-described straddle-type vehicle, and may be used in other types of straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, a first aspect provides an intake structure for a straddle-type vehicle (1) for guiding air toward an intake port (64) of an air cleaner (61), the intake structure including: a seat (27) that is located above the air cleaner; and a rear fender (33) that is located behind the air cleaner, in which a rear lower surface of the seat and a front upper surface of the rear fender face each other to form an intake passage, and in which a recess (71) that extends from a position behind a rear end (29) of the seat to a position in front of the rear end of the seat in a top view of the straddle-type vehicle (1) is formed in the front upper surface of the rear fender. According to this configuration, the intake passage is widened by forming the recess in the upper surface of the rear fender, and the amount of intake air that is guided to the intake port of the air cleaner can be increased to improve the engine output. Since the foreign matter such as water or mud that is splashed by the rear wheel is less likely to adhere to the upper surface of the rear fender, the foreign matter can be prevented from entering the intake port even if the recess is formed in the upper surface of the rear fender. Therefore, it is possible to ensure a sufficient amount of intake air while preventing the foreign matter from entering the air cleaner.

A second aspect is directed to the first aspect, in which the recess is wider from rear toward front in the top view. According to this configuration, the intake passage is widened from the rear to the front of the recess so that air flows smoothly, and the rear end side (the inlet side) of the recess is narrowed so that entry of the foreign matter is prevented.

A third aspect is directed to the first or second aspect, in which a pair of wall portions (72) that extend forward from both ends of a front end portion of the recess in a vehicle width direction are provided on the front upper surface of the rear fender, and in which the pair of wall portions are formed such that a facing interval is widened from rear toward front in the top view. According to this configuration, the pair of wall portions gradually widen the intake passage from the recess toward the intake port, and air flows smoothly. The gap between the seat and the rear fender is filled with the pair of wall portions to improve the design.

A fourth aspect is directed to any one of the first to third aspects, in which a rib (73) that extends in a vehicle width direction across the intake passage is provided on the front upper surface of the rear fender, and in which the rib is longer than a width dimension of the recess and a width dimension of the intake port. According to this configuration, it is possible to prevent entry of the foreign matter without hindering the flow of air to the intake port by the rib.

A fifth aspect is directed to the fourth aspect, in which the rib is curved so as to be convex rearward in the top view. According to this configuration, the foreign matter can be guided to the outer side in the vehicle width direction by the rib, and the foreign matter can be prevented from entering the intake port.

A sixth aspect is directed to the fourth or fifth aspect, in which the rib is located at an upper position than the intake port. According to this configuration, the height of the rib can be kept small, and the flow of air toward the intake port is less likely to be hindered by the rib. The height of the rib is reduced, so that the influence on the peripheral components is reduced, and the degree of freedom in the shape of the rear fender is improved.

A seventh aspect is directed to any one of the fourth to sixth aspects, in which a distance between the rib and the recess is shorter than a distance between the rib and the intake port. According to this configuration, entry of the foreign matter can be prevented at a position away from the intake port. The gap under the seat is filled with the rib to improve the design.

Although the present embodiment is described, a part or all of the above-described embodiment and modifications may be combined as another embodiment.

The technique according to the present invention is not limited to the above-described embodiment, and may be variously changed, replaced, or modified without departing from the gist of the technical concept. Further, the present invention may be implemented by other methods as long as the technical concept can be implemented by the methods through advance of the technique or other derivative techniques. Therefore, the claims cover all embodiments that may fall within the scope of the technical concept.

What is claimed is:

1. An intake structure for a straddle-type vehicle for guiding air toward an intake port of an air cleaner, the intake structure comprising:
a seat that is located above the air cleaner; and
a rear fender that is located behind the air cleaner,
wherein a rear lower surface of the seat and a front upper surface of the rear fender face each other to form an intake passage, and
wherein a recess that extends from a position behind a rear end of the seat to a position in front of the rear end of the seat in a top view of the straddle-type vehicle is formed in the front upper surface of the rear fender.

2. The intake structure according to claim 1,
wherein the recess is wider from rear toward front in the top view.

3. The intake structure according to claim 1,
wherein a pair of wall portions that extend forward from both ends of a front end portion of the recess in a vehicle width direction are provided on the front upper surface of the rear fender, and
wherein the pair of wall portions are formed such that a facing interval is widened from rear toward front in the top view.

4. The intake structure according to claim 1,
wherein a rib that extends in a vehicle width direction across the intake passage is provided on the front upper surface of the rear fender, and
wherein the rib is longer than a width dimension of the recess and a width dimension of the intake port.

5. The intake structure according to claim 4,
wherein the rib is curved so as to be convex rearward in the top view.

6. The intake structure according to claim 4,
wherein the rib is located at an upper position than the intake port.

7. The intake structure according to claim 4,
wherein a distance between the rib and the recess is shorter than a distance between the rib and the intake port.
